(19) United States
(12) Patent Application Publication
(10) Pub. No.: US 2026/0118813 A1
(43) Pub. Date: Apr. 30, 2026

(54) IMAGE FORMING APPARATUS THAT CONVEYS RECORDING MATERIAL WHILE NIPPING RECORDING MATERIAL

(71) Applicant: CANON KABUSHIKI KAISHA, Tokyo (JP)

(72) Inventor: HIROHIKO AIBA, Shizuoka (JP)

(21) Appl. No.: 19/372,697

(22) Filed: Oct. 29, 2025

(30) Foreign Application Priority Data
Oct. 31, 2024 (JP) 2024-192415

(51) Int. Cl. G03G 15/00; G03G 15/20

(52) U.S. Cl. CPC G03G 15/6558; G03G 15/2039; G03G 15/2064; G03G 15/657; G03G 2215/00409; G03G 2215/00413; G03G 2215/2045

(57) ABSTRACT

An image forming apparatus performs an inter-material control in a case where a developed image satisfying a condition for executing the inter-material control will be formed on a material. The condition is that a ratio of an area of the developed image that is formed in a third region to an area of the third region exceeds a threshold. The third region is a region between a first region and a second region. The first region and the second region are, respectively, a region that is downstream of a nipped region and a region that is upstream of the nipped region.

### BACKGROUND

### Field of the Technology

The present disclosure relates to an image forming apparatus that conveys a recording material while nipping the recording material.

### Description of the Related Art

Japanese Patent Laid-Open No. 2007-304167 indicates that a conveyance speed of a fixing unit is decreased in order to suppress an image defect occurring due to conveyance of a recording material.

### SUMMARY

The disclosure provides an image forming apparatus comprising: a storage unit that stores a recording material therein; a feed unit that feeds the recording material stored in the storage unit; a conveyance unit that forms a conveyance nip, the conveyance unit nipping the recording material fed by the feed unit in the conveyance nip to convey the recording material in a conveyance direction; a transfer unit that is located on the conveyance-direction downstream side of the conveyance unit in the conveyance direction and that is adjacent to the conveyance unit, the transfer unit forming a transfer nip and nipping the recording material conveyed from the conveyance unit in the transfer nip to transfer a developed image onto a transfer-receiving surface of the recording material; a fixing unit that is located on the conveyance-direction downstream side of the transfer unit in the conveyance direction, the fixing unit fixing the developed image having been transferred onto the recording material; and a control unit that performs inter-material control for, when a first recording material and a subsequently-conveyed second recording material are being conveyed to the conveyance unit, performing conveyance in a state in which a material-to-material distance between the first and second recording materials is expanded. The control unit performs the inter-material control in a case where a developed image satisfying a condition for executing the inter-material control will be formed on the second recording material. The condition is that a ratio of an area of the developed image that is formed in a third region to an area of the third region exceeds a threshold, where the third region is a region between a first region and a second region, the first region and the second region are, respectively, a region that is downstream of a nipped region in the conveyance direction and that is located at a distance of 10 mm from a center line of the nipped region and a region that is upstream of the nipped region in the conveyance direction and that is located at a distance of 10 mm from the center line of the nipped region, and the nipped region is a region constituting part of the transfer-receiving surface of the second recording material and that is nipped in the transfer nip at a time point when a rear end of the second recording material in the conveyance direction has passed through the conveyance nip.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram describing a structure of an image forming apparatus.

FIG. 2 is a diagram describing a structure of a fixing device.

FIGS. 3A to 3C are diagrams describing sheet behavior.

FIGS. 4A to 4C are diagrams describing an image defect.

FIG. 5 is a diagram describing CPU functions.

FIG. 6 is a flowchart illustrating feed control.

FIG. 7 is a diagram describing a determination-target image region.

FIG. 8 is a diagram describing images used in experiments.

FIGS. 9A and 9B are diagrams describing experiment results for comparative examples.

FIGS. 10A and 10B are diagrams describing effects of embodiments and the comparative examples.

FIGS. 11A and 11B are diagrams illustrating experiment results for the embodiments.

FIG. 12 is a flowchart illustrating feed control.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### 1. Image Forming Apparatus

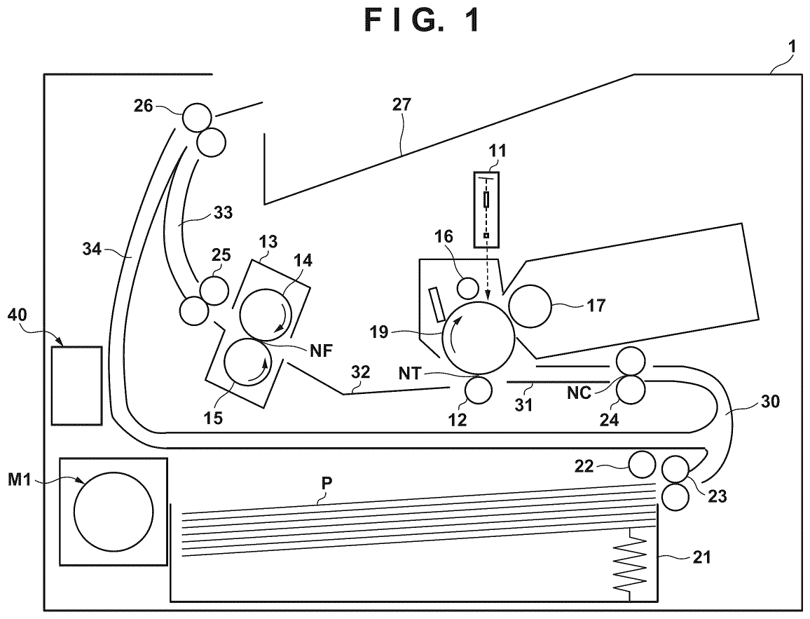

An image forming apparatus 1 illustrated in FIG. 1 is an electrophotographic printer. A photosensitive drum 19 is an image carrier that rotates while carrying an electrostatic latent image and a toner image. A charging roller 16 is a charging member that charges the surface of the photosensitive drum 19. The charging member may be a discharge wire. An exposure device 11 is a light source that forms the electrostatic latent image by irradiating the surface of the photosensitive drum 19 with light in accordance with image data. The light source is a laser, a light-emitting diode, or the like. A developing roller 17 is a developing member that develops the electrostatic latent image using toner to form the toner image. The toner image is conveyed to a transfer nip NT as a result of the photosensitive drum 19 rotating. The transfer nip NT is formed by the photosensitive drum 19 and a transfer roller 12 facing one another. In other words, the transfer roller 12 forms the transfer nip NT together with the photosensitive drum 19. The transfer roller 12 may be a transfer member of a different shape, such as a transfer blade.

A sheet cassette 21 is a storage (storage unit) that holds a plurality of sheets P. A pickup roller 22 is a feed unit that picks up and conveys a sheet P held in the sheet cassette 21. A feed-roller pair 23 is disposed on the downstream side of the pickup roller 22 in a conveyance direction of the sheet P. The feed-roller pair 23 conveys the sheet P along a conveyance path 30. A registration-roller pair 24 is a conveyance unit that is disposed on the downstream side of the feed-roller pair 23. The registration-roller pair 24 conveys the sheet P to the transfer nip NT through a conveyance path 31. The registration-roller pair 24 includes two conveyance rollers that form a conveyance nip NC. By rotating while nipping the sheet P therebetween, the two conveyance rollers convey the sheet P from the upstream side to the downstream side.

In the transfer nip NT, the toner image is transferred from the photosensitive drum 19 onto the sheet P. By the photosensitive drum 19 and the transfer roller 12 rotating while nipping the sheet P therebetween, the sheet P is conveyed further toward the downstream side. The photosensitive drum 19 and the transfer roller 12 form a transfer unit.

A fixing device 13 is disposed on the downstream side of the transfer nip NT. A conveyance path 32 is provided between the transfer nip NT and the fixing device 13. The fixing device 13 includes a heating film 14 and a pressing roller 15. The heating film 14 is a heating portion that applies heat to the sheet P and the image. The pressing roller 15 is a pressing portion that applies pressure to the sheet P and the image. A fixing nip NT is formed between the heating film 14 and the pressing roller 15. By the heating film 14 and the pressing roller 15 rotating while nipping the sheet P, heat and pressure are applied to the toner image and the sheet P. Thus, the toner image is fixed onto the sheet P.

A conveyance-roller pair 25 is disposed on the downstream side of the fixing device 13. The conveyance-roller pair 25 conveys the sheet P along a conveyance path 33. A discharge-roller pair 26 discharges the sheet P onto a sheet tray 27. There are cases in which images are formed on both sides of the sheet P. In such a case, the sheet P having an image formed on a first surface thereof is sent into an auxiliary conveyance path 34 by the discharge-roller pair 26 rotating in reverse. The sheet P is conveyed through the auxiliary conveyance path 34 and is conveyed to the transfer nip NT again. Then, an image is formed on a second surface of the sheet P.

A motor M1 rotationally drives rotating members such as the transfer roller 12, the photosensitive drum 19, the pressing roller 15, and the registration-roller pair 24. That is, the transfer roller 12 and the fixing device 13 are rotationally driven by the motor M1, i.e., the same drive source (driving unit). A controller 40 controls the feed timing of the sheet P by the pickup roller 22, and controls the temperature of the heating film 14.

The image forming apparatus 1 can form images continuously on a plurality of sheets P by repeating the electrophotographic process. For example, the image forming apparatus 1 can form black-and-white images on plain A4-size paper (210 mm×297 mm) at a process speed of 311 mm/s (55 sheets per minute). For thick paper, the image forming apparatus 1 forms images at a process speed of 195 mm/s (30 sheets per minute) in order to ensure fixation to thick paper. Note that thick paper has a higher grammage than plain paper. Note that these numerical values are mere examples. Even if the process speed (conveyance speed) is the same, the number of images that can be formed per unit time (throughput) would differ if the conveyance interval is different.

### 2. Structure of Fixing Device

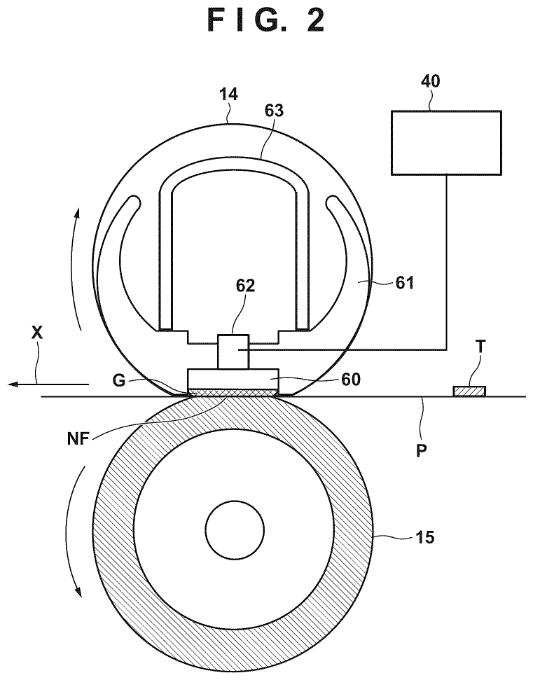

FIG. 2 illustrates the fixing device 13. The heating film 14 is a fixing member that is formed from an endless belt. The pressing roller 15 is a pressing member that has the shape of a roller. A heater 60 is a heating member that is disposed to slide relative to the inner circumferential surface of the heating film 14.

The heating film 14 is a heat-resistant and elastic cylinder that is formed from a plurality of layers. For example, a base layer includes a thin heat-resistant resin such as polyimide, or a thin metal such as stainless steel. A release layer may be formed on the surface of the heating film 14. For example, the release layer contains a heat-resistant resin having excellent releasability, such as a tetrafluoroethylene-perfluoroalkyl vinyl ether copolymer (PFA). This suppresses the adhesion of toner to the heating film 14, and also facilitates separation of sheets P from the heating film 14. An elastic layer may be disposed between the base layer and the release layer. For example, the elastic layer contains heat-resistant rubber such as silicone rubber.

The pressing roller 15 includes a core metal and an elastic layer. For example, the core metal is formed from iron, aluminum, or the like. For example, the elastic layer is formed from silicone rubber or the like. The heater 60 is held by a holding member 61. The holding member 61 is held by a metal stay member 63. The stay member 63 presses the heater 60 against the inner circumferential surface of the heating film 14 via the holding member 61. A lubricant G may be applied between the heater 60 and the heating film 14. For example, the lubricant G may be a mixture of a fluororesin such as polytetrafluoroethylene and a fluorinated oil such as perfluoropolyether. This reduces the sliding contact between the heater 60 and the heating film 14.

A pressing force is applied between the stay member 63 and the pressing roller 15 by an unillustrated pressing mechanism. The fixing nip NF is formed by the pressing roller 15 being pressed against the heater 60 with the heating film 14 therebetween. The motor M1 causes the pressing roller 15 to rotate counterclockwise. Thus, the heating film 14 also rotates clockwise by being driven by the pressing roller 15. A toner image T is fixed onto a sheet P as a result of the sheet P passing through the fixing nip NF.

For example, the heater 60 is a ceramic heater including a ceramic substrate and a heating element provided on the substrate. A thermistor 62 is a temperature sensor that is disposed so as to be in contact with the heater 60. The controller 40 controls the power supplied to the heater 60 based on the result of the sensing by the thermistor 62. Thus, the temperature of the heating film 14 is maintained at a target temperature.

### 3. Behavior of Sheet P when Passing Through Transfer Nip NT

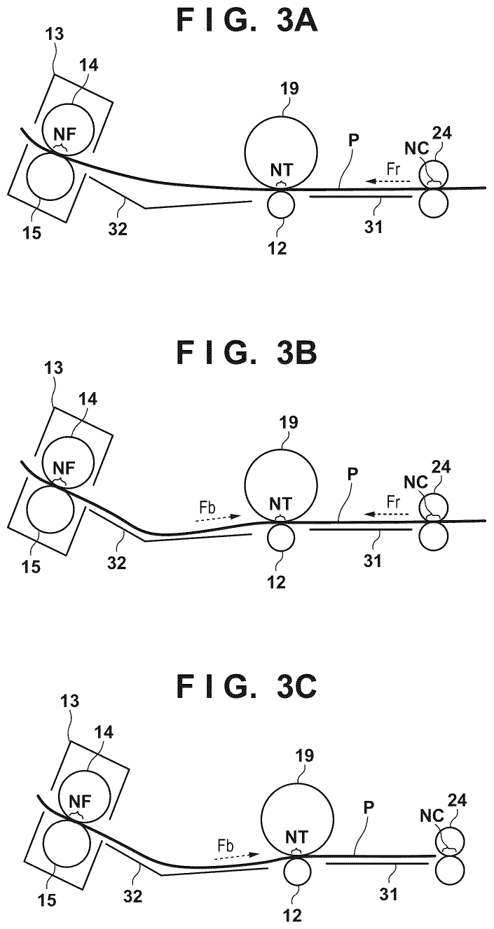

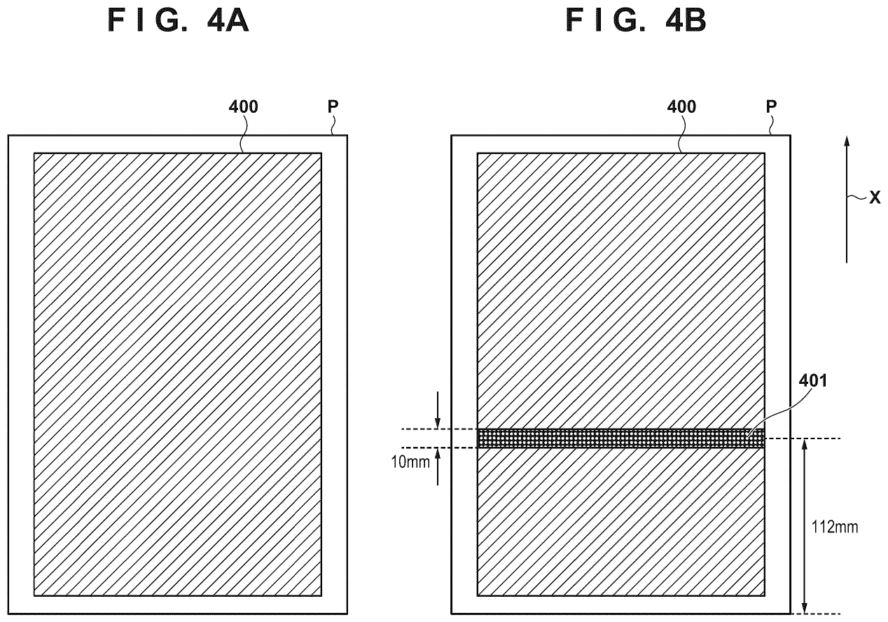

FIG. 3A illustrates a conveyance area from the conveyance nip NC of the registration-roller pair 24 to the fixing nip NF of the fixing device 13. A sheet P passes through the registration-roller pair 24 disposed on the upstream side of the transfer nip NT. Next, the sheet P passes through the transfer nip NT. Finally, the sheet P passes through the fixing device 13.

Mainly, the registration-roller pair 24 and the fixing device 13 are the members that contribute to the conveyance of the sheet P within this area. The photosensitive drum 19 and the transfer roller 12 nip the sheet P in the transfer nip NT. However, the pressure applied to the transfer nip NT is relatively small. Thus, the degree of contribution of the transfer nip NT to the conveyance is smaller than those of the registration-roller pair 24 and the fixing device 13.

Furthermore, FIG. 3A also illustrates an ideal state in which the sheet P is neither over-tensioned nor excessively slack between the transfer nip NT and the fixing device 13. The sheet P receives a force Fr from the registration-roller pair 24.

When the pressing roller 15 expands, the radius of the pressing roller 15 increases, and the peripheral speed of the pressing roller 15 (conveyance speed of the sheet P) increases. In such a case, the fixing device 13 may pull the sheet P excessively. This may result in abnormal electric discharge between the photosensitive drum 19 and the sheet P due to a decrease in the distance between the photosensitive drum 19 and the sheet P on the downstream side of the transfer nip NT. This may cause an image defect. Thus, the peripheral speed of the registration-roller pair 24 and the peripheral speed of the fixing device 13 are designed so that the pressing roller 15 does not pull the sheet P excessively even if the temperature of the fixing device 13 increases and the pressing roller 15 undergoes maximum thermal expansion.

FIG. 3B illustrates a state in which the fixing device 13 is not sufficiently heated. If printing is executed in a state in which the pressing roller 15 has hardly undergone any thermal expansion, slack occurs in the sheet P. This is because the fixing device 13 pulls the sheet P at a low speed, and the speed at which the registration-roller pair 24 feeds the sheet P becomes relatively high. In this case, a force Fb acting to take up the slack acts on the sheet P. The higher the stiffness of the sheet P is (e.g., in the case of thick paper, etc.), the greater the force Fb may become. While the sheet P is being conveyed by the registration-roller pair 24, the force Fr with which the registration-roller pair 24 conveys the sheet P cancels out the force Fb acting to take up the slack.

FIG. 3C illustrates a state in which the rear end of the sheet P has passed through the registration-roller pair 24. In this state, the conveyance force Fr of the registration-roller pair 24 no longer acts on the sheet P. For an instant, the sheet P moves so as to return to the upstream side due to the force Fb acting to take up the slack. This results in image distortion at the transfer nip NT.

The image distortion occurs within a specific surface region (specific region) of the sheet P. The specific region is the surface region onto which toner is being transferred in the transfer nip NT at the timing when the rear end of the sheet P has passed through the registration-roller pair 24. In the first embodiment, the distance between the transfer nip NT and the conveyance nip NC of the registration-roller pair 24 is 112 mm, for example. For example, the width of the region in which toner is transferred onto the sheet P by a transfer voltage being applied in the transfer nip NT is approximately 10 mm. The image distortion occurs within the specific region present at a distance of around 112±5 mm from the rear end of the sheet P.

Incidentally, the image that will be transferred onto the sheet P is dependent on image data. Thus, there are cases in which no image is transferred onto the specific region. There are also cases in which an image consisting of small characters or the like is transferred onto the specific region. In such cases, the image distortion would not be visible to humans.

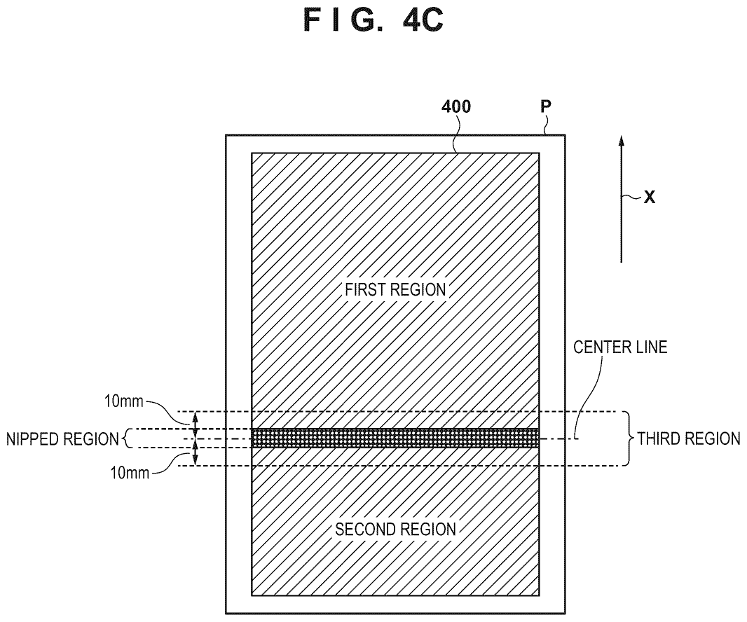

On the other hand, depending on the image formed in the specific region, there are also cases in which the defect is readily visible. FIG. 4A illustrates a uniform halftone image 400. FIG. 4B illustrates the image distortion. X indicates the conveyance direction of the sheet P. As illustrated in FIGS. 4A and 4B, the image distortion tends to appear as a density difference in the halftone image 400. In this example, the image distortion has occurred in a specific region 401. The specific region 401 is present within 112±5 mm from the rear end of the sheet P. Hereinafter, the image distortion may be referred to as a blurred image.

As a method for preventing a blurred image, there is a method of increasing the temperature of the pressing roller 15 and causing the pressing roller 15 to undergo thermal expansion by heating and rotating the pressing roller 15 without any sheet P passing through the fixing device 13. This would allow sheets P to be conveyed in the ideal position.

### 4. Inter-Material Control

FIG. 4C is a diagram illustrating a condition for material-to-material-distance expansion control. In embodiment 1, a material-to-material distance, which is the conveyance interval between a preceding sheet P and a subsequent sheet P, is expanded if a condition under which a blurred image is likely to be formed on the subsequent sheet P is satisfied.

In FIG. 4C, an image formed on the transfer-receiving surface of a sheet P is divided into three regions. Each of first, second, and third regions is a region constituting part of the transfer-receiving surface. A nipped region is also a region constituting part of the transfer-receiving surface, and is a region that is nipped in the transfer nip NT at the time point when the rear end of the sheet P in the conveyance direction X has passed through the conveyance nip NC. The first region is a region that is downstream of the nipped region in the conveyance direction and that is separated by a distance of 10 mm from the center line of the nipped region. The center line of the nipped region is a line that extends in a direction orthogonal to the conveyance direction. Alternatively, the center line may be defined as a line that equally divides the third region in the conveyance direction. The second region is a region that is upstream of the nipped region in the conveyance direction and that is separated by a distance of 10 mm from the center line of the nipped region. The third region is the region between the first region and the second region. The condition for expanding the conveyance interval is defined in regard to the subsequent sheet P. For example, the condition is that the ratio of the area of a developed image that is formed in the third region to the area of the third region exceeds a threshold. Alternatively, the condition may be that a halftone image will be formed over the entire third region. As described later, a sub-condition deriving from an image that will be formed in the third region and another sub-condition may be combined. As the other sub-condition, a condition relating to at least one of: the grammage of sheets P; the temperature of the pressing roller 15; the temperature in the environment in which the pressing roller 15 is installed; the expansion amount of the pressing roller 15; the movement speed of the peripheral surface of the pressing roller 15; and the degree of wear of the registration-roller pair 24 can be adopted.

### 5. Controller

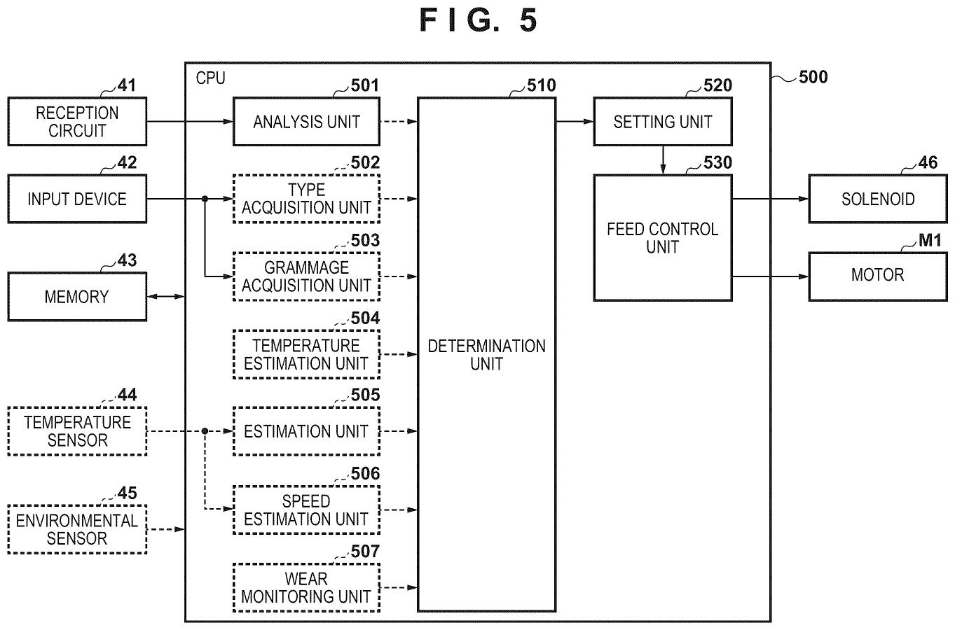

FIG. 5 illustrates functions of a CPU 500 installed in the controller 40. The CPU 500 realizes various functions by executing a control program. One or more of the various functions may be implemented in an integrated circuit that is different from the CPU 500.

A reception circuit 41 receives image data from a host computer, a document reader, or a digital camera. An analysis unit 501 analyzes the image data and acquires an image amount that will be formed in the third region of a sheet P. The image amount may be the ratio of the area of the developed image that is formed in the third region to the area of the third region. A determination unit 510 compares a threshold stored in a memory 43 and the image amount that will be formed in the third region. For example, it is determined whether or not the image amount is more than the threshold, and the result of the determination is output to a setting unit 520. The setting unit 520 determines a conveyance interval in accordance the result of the determination, and sets the conveyance interval to a feed control unit 530. The feed control unit 530 drives a solenoid 46 and lowers the pickup roller 22 at a feed timing such that the set conveyance interval is satisfied. Thus, the pickup roller 22 comes into contact with the sheet P and feeds the sheet P.

An input device 42 may include a touch panel sensor, a numeric keypad, or the like. A type acquisition unit 502 is optional, and acquires the type of sheets P (e.g., thick paper, thin paper, or plain paper) based on job information received by the reception circuit 41 or information input by a user via the input device 42. A grammage acquisition unit 503 is optional, and acquires the grammage of sheets P based on information input by the user via the input device 42. The grammage may be input as a numerical value via the input device 42. Alternatively, a grammage corresponding to the sheet type that has been input may be acquired from a database stored in the memory 43.

A temperature estimation unit 504 is optional, and estimates the temperature of the pressing roller 15. The estimated temperature of the pressing roller 15 is a parameter that is correlated with the expansion amount, radius, circumference, and peripheral speed of the pressing roller 15. The temperature estimation unit 504 may estimate the temperature of the pressing roller 15 using a sensing result from an environmental sensor 45 that senses the temperature and humidity in an installation environment in which the image forming apparatus 1 is installed. The temperature of the pressing roller 15 may be estimated based on at least one of the environmental temperature, the quantity of sheets P having passed through the fixing device 13, the target temperature of the heater 60, a pass time and a no-pass time, the temperature of the heating film 14, etc. The temperature of the heating film 14 can be acquired by means of the thermistor 62. The pass time is time during which a sheet P passes through the fixing device 13. The no-pass time is time during which a sheet P is not passing through the fixing device 13. In such a manner, if a sheet P passes through the pressing roller 15, the temperature of the pressing roller 15 decreases due to the sheet P taking heat away from the pressing roller 15. Conversely, during a period in which a sheet P is not passing through the pressing roller 15, the temperature of the pressing roller 15 increases because no sheet P takes heat away from the pressing roller 15. The higher the environmental temperature, the less the amount of heat dissipated to the atmosphere from the pressing roller 15. The lower the environmental temperature, the more the amount of heat dissipated to the atmosphere from the pressing roller 15. The more the quantity of sheets P, the more the amount of heat accumulated in the pressing roller 15. Accordingly, the temperature estimation unit 504 can estimate the temperature of the pressing roller 15 by taking such parameters into consideration. A mathematical function (formula) or a program module that receives such parameters as an input value and outputs the temperature of the pressing roller 15 as an output value may be stored in the memory 43.

An expansion estimation unit 505 is optional, and estimates the expansion amount of the pressing roller 15. For example, the expansion estimation unit 505 estimates the expansion amount based on a result of sensing by a temperature sensor 44 that measures the temperature of the pressing roller 15 or the temperature in the vicinity of the pressing roller 15. The memory 43 may store therein a table or a formula for converting the sensed temperature into an expansion amount.

A speed estimation unit 506 is optional, and estimates the peripheral speed (the movement speed of the peripheral surface) of the pressing roller 15. For example, the speed estimation unit 506 may estimate the movement speed based on the sensed temperature or estimated temperature of the pressing roller 15. The memory 43 may store therein a table or a formula for converting temperature into a peripheral speed.

The determination unit 510 determines whether or not the parameter(s) acquired by the analysis unit 501, etc., satisfy the condition. For example, the likelihood of a visible image defect occurring is high if the image amount in the third region of the sheet P exceeds the threshold. The likelihood of a visible image defect not occurring is high if the image amount in the third region does not exceed the threshold. Furthermore, the likelihood of a visible image defect occurring is high also if a halftone image will be formed over the entire third region. The condition may be that the expansion amount of the pressing roller 15 is less than a first threshold, and the ratio of the area of the developed image that is formed in the third region to the area of the third region exceeds the threshold. The condition may be that the expansion amount of the pressing roller 15 is less than the first threshold, and a halftone image will be formed over the entire third region. The condition may be that the temperature of the pressing roller 15 is lower than a first threshold, and the ratio of the area of the developed image that is formed in the third region to the area of the third region exceeds the threshold. The condition may be that the temperature is lower than the first threshold, and a halftone image will be formed over the entire third region. The condition may be that the movement speed of the peripheral surface of the pressing roller 15 is lower than a first threshold, and the ratio of the area of the developed image that is formed in the third region to the area of the third region exceeds the threshold. The condition may be that the movement speed of the peripheral surface of the pressing roller 15 is lower than the first threshold, and a halftone image will be formed over the entire third region. The condition may be that the grammage of sheets P is higher than a first threshold, and the ratio of the area of the developed image that is formed in the third region to the area of the third region exceeds the threshold. The condition may be that the grammage of sheets P is higher than the first threshold, and a halftone image will be formed over the entire third region. The condition may be that the temperature of the environment in which the fixing device 13 is installed is lower than a first threshold, and the ratio of the area of the developed image that is formed in the third region to the area of the third region exceeds the threshold. The condition may be that the temperature of the environment in which the fixing device 13 is installed is lower than the first threshold, and a halftone image will be formed over the entire third region.

If the condition is satisfied, the setting unit 520 sets a first value to the conveyance interval. If the condition is not satisfied, the setting unit 520 sets a second value to the conveyance interval. If a developed image satisfying the condition will not be formed on the subsequent sheet P, the inter-material control for expanding the conveyance interval is not executed. For example, the conveyance interval need not be expanded if the expansion amount of the pressing roller 15 is more than the first threshold, or the ratio of the area of the developed image that is formed in the third region to the area of the third region does not exceed the threshold. The conveyance interval need not be expanded if the expansion amount of the pressing roller 15 is more than the first threshold, or a halftone image will not be formed over the entire third region. The conveyance interval need not be expanded if the temperature of the pressing roller 15 is higher than the first threshold, or the ratio of the area of the developed image that is formed in the third region to the area of the third region does not exceed the threshold. The conveyance interval need not be expanded if the temperature is higher than the first threshold, or a halftone image will not be formed over the entire third region. The conveyance interval need not be expanded if the movement speed of the peripheral surface of the pressing roller 15 is higher than the first threshold, or the ratio of the area of the developed image that is formed in the third region to the area of the third region does not exceed the threshold. The conveyance interval need not be expanded if the movement speed of the peripheral surface of the pressing roller 15 is higher than the first threshold, or a halftone image will not be formed over the entire third region. The conveyance interval need not be expanded if the grammage of the sheet P is lower than the first threshold, or the ratio of the area of the developed image that is formed in the third region to the area of the third region does not exceed the threshold. The conveyance interval need not be expanded if the grammage is lower than the first threshold, or a halftone image will not be formed over the entire third region. The conveyance interval need not be expanded if the environmental temperature is higher than the first threshold, or the ratio of the area of the developed image that is formed in the third region to the area of the third region does not exceed the threshold. The conveyance interval need not be expanded if the environmental temperature is higher than the first threshold, or a halftone image will not be formed over the entire third region. The setting of the second value to the conveyance interval includes a case in which the conveyance interval is not expanded.

The first value is greater than the second value. By increasing the conveyance interval, the temperature, expansion amount, peripheral speed, and radius of the pressing roller 15 each increase to within an appropriate range, and an image defect is suppressed. By decreasing the conveyance interval, the quantity of images formed per unit time increases. In other words, user waiting time decreases.

A wear monitoring unit 507 estimates and monitors the amount of wear of the registration-roller pair 24. The wear monitoring unit 507 estimates the amount of wear in accordance with the quantity of sheets P having passed through the registration-roller pair 24. The amount of wear increases in accordance with the quantity of sheets P. Furthermore, the more the amount of wear is, the less likely a blurred image is formed.

### 6. Flowchart

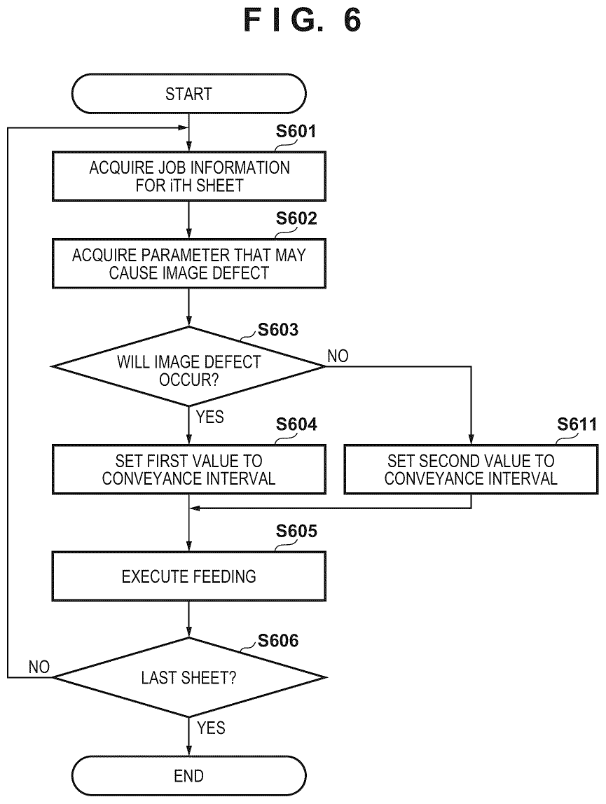

FIG. 6 illustrates feed control executed by the CPU 500 in accordance with the control program. As one example, a case will be assumed in which printing is executed on a plurality of sheets of thick A4-size paper (210 mm×297 mm). In accordance with job information, the CPU 500 (feed control unit 530) starts to drive the motor M1 and starts image formation. The CPU 500 determines the target temperature in accordance with the job information, and controls the heater 60 so that the temperature sensed by the thermistor 62 equals the target temperature. The job information may include an instruction to form images on N sheets P, information about the type of the sheets P, and image data for the individual sheets P. In the following, an index i is used to distinguish the individual sheets P from one another.

In step S601, the CPU 500 (analysis unit 501) acquires job information for the ith sheet Pi.

In step S602, the CPU 500 (analysis unit 501) acquires a parameter that may cause an image defect (blurred image). For example, the CPU 500 acquires image data for the ith sheet Pi included in the job information, and acquires the image amount in the third region.

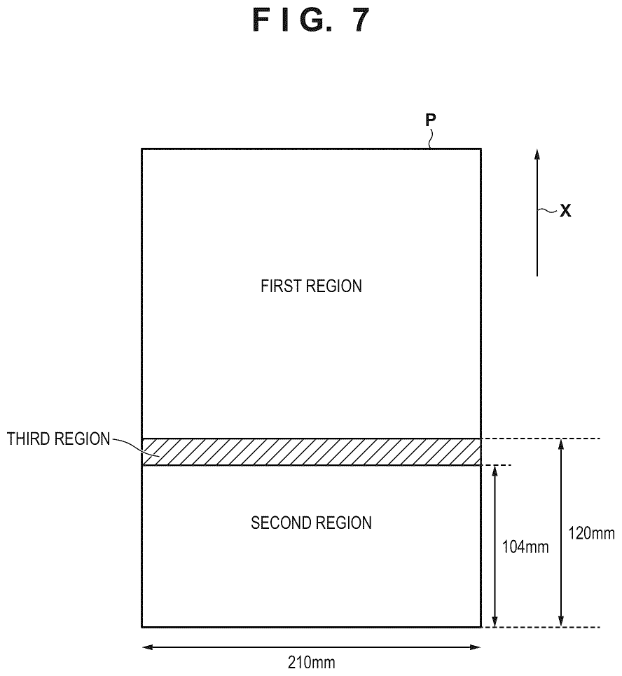

FIG. 7 illustrates another example of the third region of the sheet P. According to FIG. 4C, the third region is present at a distance of around 112±10 mm from the rear end of the sheet P. However, this is merely one example. The region in which a blurred image may be formed is present at a distance of around 112±5 mm from the rear end of the sheet P. In view of this, a small margin is added and the third region is set within 112±8 mm from the rear end of the sheet P. That is, as the third region, image data corresponding to an area from a position at a distance of 104 mm from the rear end of the sheet P to a position at a distance of 120 mm from the rear end of the sheet P is analyzed. The third region has a size of 210 mm×16 mm. The image amount may be the area in which an image will be formed in the third region. The image amount may be the area of the region in which an image will be formed relative to the total area of the third region.

In step S603, the CPU 500 (determination unit 510) determines whether or not an image defect will occur in the third region. That is, the CPU 500 (determination unit 510) determines whether or not the above-described condition is satisfied in regard to the subsequent sheet P. For example, the CPU 500 may determine whether or not the image amount in the third region exceeds the threshold (e.g., 20%). If the image amount exceeds the threshold, the CPU 500 advances from step S603 to step S604 because it is likely that a blurred image will be formed.

In step S604, the CPU 500 (setting unit 520) sets the first value to the conveyance interval. The first value is a value that reduces the likelihood of an image defect occurring. For example, the first value is a value (e.g., four seconds) that is obtained by adding a predetermined value (e.g., two seconds) to the default conveyance interval (e.g., two seconds). For example, the first value may be a value with which 15 images can be printed per minute. Subsequently, the CPU 500 advances processing from step S604 to step S605.

If the image amount does not exceed the threshold, the CPU 500 advances from step S603 to step S611 because it is unlikely that a blurred image will be formed. In step S611, the CPU 500 (setting unit 520) sets the second value to the conveyance interval. The second value is a value with which the quantity of images formed per unit time would increase. For example, the second value is the default conveyance interval (e.g., two seconds). For example, the second value may be a value with which 30 images can be printed per minute. Subsequently, the CPU 500 advances processing from step S611 to step S605.

In step S605, the CPU 500 (feed control unit 530) executes feeding of the sheet P by, in accordance with the set conveyance interval, driving the solenoid 46 and placing the pickup roller 22 in contact with the sheet P. Subsequently, the CPU 500 advances processing from step S605 to step S606.

In step S606, the CPU 500 (analysis unit 501) determines whether or not the ith sheet Pi is the last sheet PN. In other words, it is determined whether i is equal to N. If the ith sheet Pi is not the last sheet PN, the CPU 500 increments i by one, and advances from step S606 to step S601. If the ith sheet Pi is the last sheet PN, the CPU 500 terminates image formation. The CPU 500 (feed control unit 530) stops the motor M1, and also stops the fixing device 13.

### 7. Effects of Embodiment

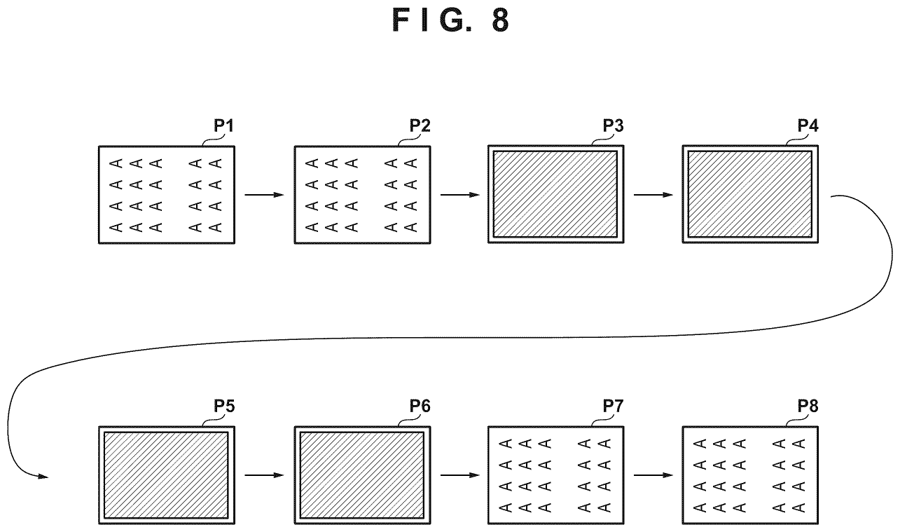

FIG. 8 illustrates a case in which images for sheets P1 to P8 are printed on thick A4-size paper. No images are present in the third regions of sheets P1, P2, P7, and P8. Images are present in the third regions of sheets P3 to P6.

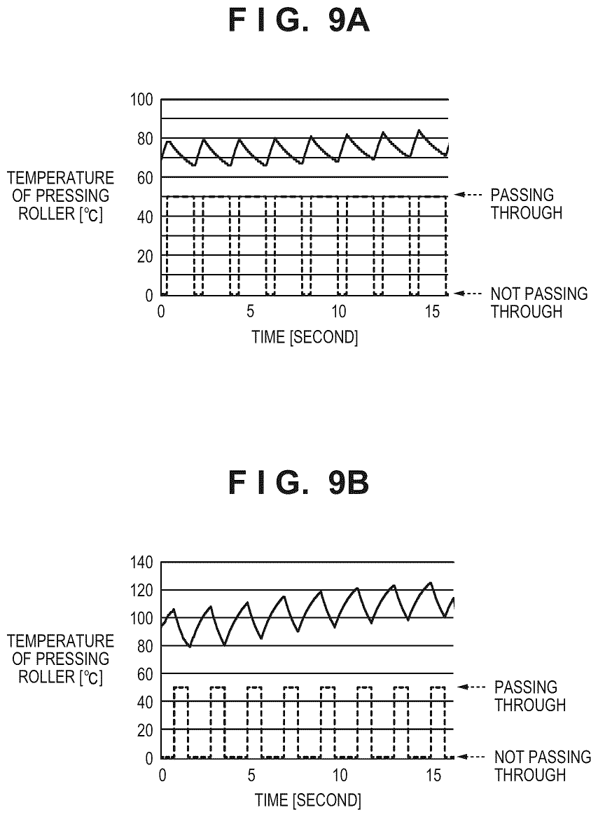

FIG. 9A illustrates an experiment example for comparative example i. The horizontal axis indicates time. The vertical axis indicates the temperature of the pressing roller 15. The solid line indicates the temperature of the pressing roller 15. The broken line indicates whether or not sheets P are passing through the fixing device 13. In comparative example i, the image forming apparatus 1 prioritizes productivity and executes printing at a speed of 30 sheets per minute, regardless of images.

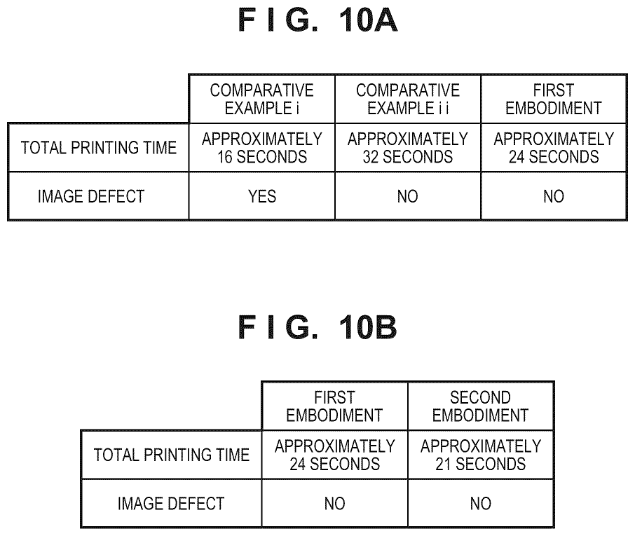

It is assumed that, if the temperature of the pressing roller 15 is 105° C. or higher at the timing when a sheet P arrives at the fixing device 13, the sheet P will not become slack between the transfer nip NT and the fixing device 13 and no blurred image will be formed. As illustrated in FIG. 10A, in comparative example i, the total printing time required to print images on eight sheets P is approximately 16 seconds. Because the no-pass time, during which a sheet P is not present in the fixing nip NF, is short, the pressing roller 15 cannot readily be heated. The temperature of the pressing roller 15 at the timing when a sheet P arrives at the fixing device 13 is around 80-85° C. Accordingly, blurred images are formed in the halftone images formed on the third to sixth sheets (sheets P3 to P6).

FIG. 9B illustrates an experiment example for comparative example ii. In comparative example ii, the image forming apparatus 1 prioritizes image quality and executes printing at a speed of 15 sheets per minute, regardless of images.

In comparative example ii, there is a no-pass time of 2 seconds or more after each sheet P passes through the fixing nip NF. Thus, the heater 60 can sufficiently heat the pressing roller 15. The temperature of the pressing roller 15 at the timing when a sheet P arrives at the fixing device 13 is always 105° C. or higher. The pressing roller 15 can undergo sufficient thermal expansion. As illustrated in FIG. 10A, no blurred images are formed in comparative example ii. The total printing time in comparative example ii is approximately 32 seconds, and the user waiting time is long.

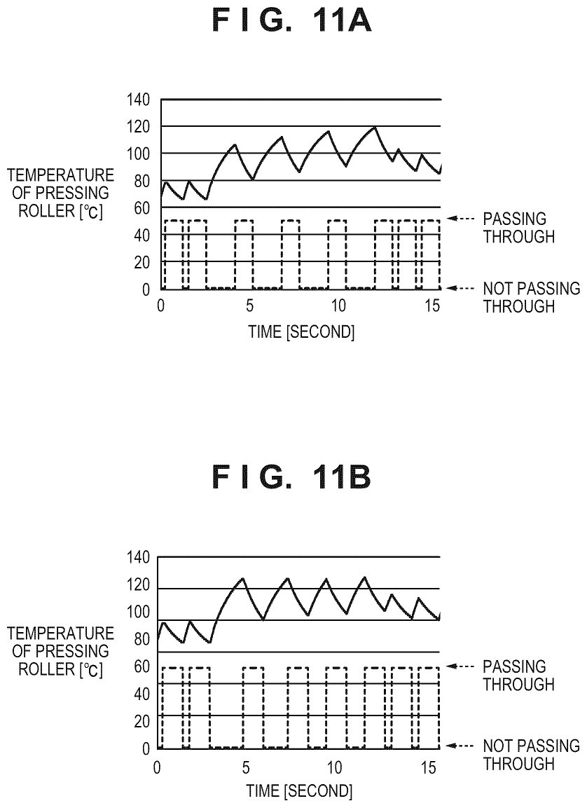

FIG. 11A illustrates an experiment example for the first embodiment. In the first embodiment, the conveyance interval is adjusted in accordance with images. No images are present in the third regions of sheets P1, P2, P7, and P8. Thus, productivity is prioritized, and printing is executed at a speed of 30 sheets per minute. Halftone images are present in the third regions of sheets P3 to P6. A long conveyance interval is adopted for sheets P3 to P6, and printing is executed at a speed of 15 sheets per minute.

As illustrated in FIG. 11A, the temperature of the pressing roller 15 is 105° C. or higher at the timing when a sheet P corresponding to sheets P3 to P6 arrives at the fixing device 13. As illustrated in FIG. 10A, the formation of blurred images is suppressed in the first embodiment. The total printing time in the first embodiment is approximately 24 seconds. The productivity in the first embodiment is higher than that in comparative example ii. Accordingly, the first embodiment can suppress an image defect and also achieve image productivity of the image forming apparatus.

In the first embodiment, the analysis-target third region has a width of 210 mm, which is the width of A4-size paper. However, this is merely one example. For example, the third region may be divided into a plurality of regions in the width direction of a sheet P, which is orthogonal to the conveyance direction of the sheet P, and the image amount may be identified for each region. In a sheet P, there may be margins in which no image is printed. Accordingly, the CPU 500 (analysis unit 501) may use information indicating positions on the sheet P where end portions of an actually printed image will be present. In this case, the CPU 500 may switch the conveyance interval using information indicating how much toner will be transferred within the area in which an image will be actually printed.

### Second Embodiment

In the first embodiment, a long conveyance interval is adopted in a case in which it is likely that an image defect will occur in the third region. In particular, in the first embodiment, one parameter, i.e., the image amount in the third region, is taken into consideration. However, this is merely one example. A plurality of parameters that may be involved in the occurrence of a blurred image may be taken into consideration. In view of this, in the second embodiment, the conveyance interval is adjusted in accordance with the degree of heat accumulation in the fixing device 13 (e.g., the temperature of the pressing roller 15), in order to improve productivity in comparison with the first embodiment. For technical features already described in the first embodiment that are also adopted in the second embodiment, the description in the first embodiment is incorporated by reference.

### 1. Operation of Image Forming Apparatus

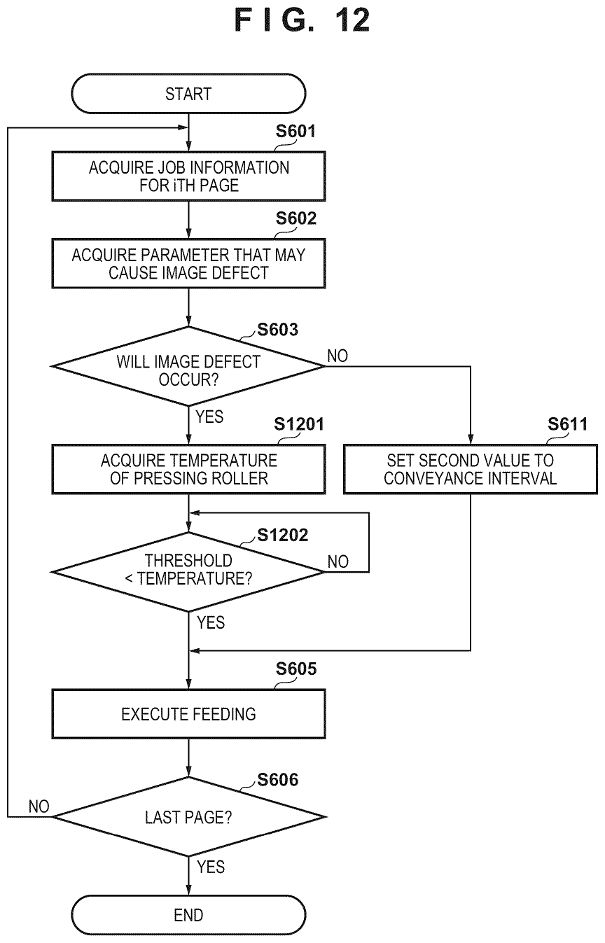

FIG. 12 illustrates feed control in the second embodiment executed by the CPU 500 in accordance with the control program. Among the steps illustrated in FIG. 12, steps that have already been described with reference to FIG. 6 are provided with the same reference symbols. In comparison with FIG. 6, step S604 is replaced with steps S1201 and S1202 in FIG. 12. If it is determined in step S603 that an image defect will occur in the third region, the CPU 500 advances processing from step S603 to step S1201.

In step S1201, the CPU 500 acquires the temperature of the pressing roller 15. This temperature may be acquired by the temperature sensor 44, or may be estimated by the temperature estimation unit 504.

In step S1202, the CPU 500 determines whether or not the temperature of the pressing roller 15 has exceeded a threshold (e.g., 105° C.). The likelihood of the sheet P becoming slack decreases if the temperature of the pressing roller 15 is 105° C. or higher at the timing when the sheet P arrives at the fixing device 13. In other words, the likelihood of a blurred image being formed in the third region is low. In view of this, the CPU 500 waits until the temperature of the pressing roller 15 equals or exceeds 105° C. If the temperature of the pressing roller 15 equals or exceeds 105° C., the CPU 500 advances processing from step S1202 to step S605.

### 2. Effects of Second Embodiment

FIGS. 10B and 11B illustrate an experiment result for the second embodiment. In the above-described first embodiment, the feed timing of a sheet P is delayed if the image amount in the third region exceeds the threshold. As illustrated in FIG. 11A, for sheets P4 to P6, the temperature of the pressing roller 15 significantly exceeds 105° C., and the temperature of the pressing roller 15 increases more than necessary.

In the second embodiment, each sheet P is fed at a timing when the temperature of the pressing roller 15 at the timing when the sheet P arrives at the fixing device 13 will be 105° C. As illustrated in FIG. 11B, the temperature of the pressing roller 15 slightly exceeds 105° C. at each timing when a sheet P corresponding to the sheets P4 to P6 arrives at the fixing device 13. Accordingly, the formation of blurred images is suppressed.

As illustrated in FIG. 10B, the total printing time in the second embodiment is approximately 21 seconds. Accordingly, the productivity in the second embodiment is higher than that in the first embodiment. According to the second embodiment, an image defect can be suppressed, and image productivity of the image forming apparatus 1 can also be achieved.

### Modifications

In the first and second embodiments, a single threshold is used to determine whether or not an image defect will occur; however, this is merely one example. Switching between three or more conveyance intervals may be performed by adopting multiple thresholds. For example, a first conveyance interval is adopted if the image amount exceeds a first threshold. A second conveyance interval is adopted if the image amount is less than the first threshold and more than a second threshold. A third conveyance interval is adopted if the image amount is less than the second threshold. The first conveyance interval is greater than the second conveyance interval. The second conveyance interval is greater than the third conveyance interval.

The CPU 500 may switch between multiple conveyance intervals in accordance with the type or grammage of sheets P. The higher the grammage is, the more likely blurred images are formed. The lower the grammage is, the less likely blurred images are formed. For example, the first conveyance interval is adopted for thick paper (first grammage). The second conveyance interval is adopted for plain paper (second grammage). The third conveyance interval is adopted for thin paper (third grammage). Alternatively, the CPU 500 may adjust the threshold relating to the image amount or the threshold relating to the temperature of the pressing roller 15 in accordance with the type or grammage of sheets P. For example, the higher the grammage, the lower the threshold compared with the image amount. For example, the lower the grammage, the higher the threshold.

The CPU 500 may switch between multiple conveyance intervals in accordance with the environmental temperature acquired by the environmental sensor 45. This is because the higher the environmental temperature is, the less likely blurred images will be formed due to sheets P becoming slack. Alternatively, the CPU 500 may adjust the threshold relating to the image amount or the threshold relating to the temperature of the pressing roller 15 in accordance with the environmental temperature.

As the registration-roller pair 24 wears out, the conveyance force of the registration-roller pair 24 decreases. In this case, the occurrence of slack in sheets P between the transfer nip NT and the fixing device 13, which is a cause of blurred images, becomes less likely. In view of this, the CPU 500 may obtain a cumulative value of the quantity of sheets P on which images have been formed in the image forming apparatus 1, and the degree of wear of the registration-roller pair 24 may be estimated from the cumulative value. For example, the first value is set to the conveyance interval if a halftone image will be formed in the third region and the degree of wear of the registration-roller pair 24 has not exceeded a threshold. The second value is set to the conveyance interval if a halftone image will not be formed in the third region or the degree of wear of the registration-roller pair 24 has exceeded the threshold. Note that, in this example, the condition that a halftone image will be formed in the third region may be replaced with the condition that the ratio of the area of the developed image that is formed in the third region to the area of the third region exceeds the threshold. Alternatively, the CPU 500 may adjust the threshold to be used in the above-described condition in accordance with the cumulative value. For example, the CPU 500 may adjust the threshold relating to the image amount or the threshold relating to the temperature of the pressing roller 15 in accordance with the cumulative value. For example, the threshold relating to the image amount may be gradually increased as the cumulative value increases. The threshold relating to the temperature of the pressing roller 15 may be gradually decreased as the cumulative value increases.

As the temperature of the pressing roller 15 increases, the radius of the pressing roller 15, the expansion amount of the pressing roller 15, and the peripheral speed of the pressing roller 15 also increase. As the temperature of the pressing roller 15 decreases, the radius of the pressing roller 15, the expansion amount of the pressing roller 15, and the peripheral speed of the pressing roller 15 also decrease. Furthermore, these parameters may all be correlated with the ratio of occurrence of an image defect. In view of this, in the first embodiment, the temperature of the pressing roller 15, the radius of the pressing roller 15, the expansion amount of the pressing roller 15, or the peripheral speed of the pressing roller 15 may be adopted as the determination target in place of the image amount.

Similarly, in the second embodiment, the radius of the pressing roller 15, the expansion amount of the pressing roller 15, or the peripheral speed of the pressing roller 15 may be adopted as the determination target in place of the temperature of the pressing roller 15. This is because these parameters may all be correlated with the ratio of occurrence of an image defect.

The CPU 500 controls the timings (feed timings) for feeding sheets P from the pickup roller 22 based on at least one parameter. The at least one parameter may include the image amount formed in a region of the sheets P that is dependent on the distance between the registration-roller pair 24 and the photosensitive drum 19, and the grammage of the sheets P. The at least one parameter may include at least one of the temperature of the pressing roller 15, the temperature in the environment in which the pressing roller 15 is installed, the expansion amount of the pressing roller 15, the movement speed of the peripheral surface of the pressing roller 15, and the degree of wear of the registration-roller pair 24.

The CPU 500 may obtain the image amount in the region based on image data serving as a source of the image, and control the feed timing based on the image amount.

If the image amount is more than a threshold, the CPU 500 may control the feed timing of a subsequent sheet P so that the distance between the subsequent sheet P and a preceding sheet P fed by the pickup roller 22 equals a first value. If the image amount is less than the threshold, the CPU 500 may control the feed timing of the subsequent sheet P so that the distance equals a second value. Here, the first value is greater than the second value. The position of the third region is a position that is dependent on the distance between the conveyance nip NC and the transfer nip NT. The length of the third region in the conveyance direction of the sheets P is no less than the length of the transfer nip NT in the conveyance direction of the sheets P.

The CPU 500 may acquire the expansion amount of the pressing roller 15. If the expansion amount is less than a first threshold and the image amount is more than a second threshold, the feed timing of a subsequent sheet P may be controlled so that the distance between the subsequent sheet P and a preceding sheet P fed by the pickup roller 22 equals the first value. If the expansion amount is more than the first threshold or the image amount is less than the second threshold, the feed timing of the subsequent sheet P may be controlled so that the distance equals the second value.

If the expansion amount is less than a threshold, the CPU 500 may control the feed timing of a subsequent sheet P so that the distance between the subsequent sheet P and a preceding sheet P equals the first value. If the expansion amount is more than the threshold, the CPU 500 may control the feed timing of a subsequent sheet P so that the distance between the subsequent sheet P and a preceding sheet P equals the second value. In such a manner, the image amount need not be taken into consideration.

There are cases in which the temperature of the pressing roller 15 is lower than a first threshold, and the image amount is more than a second threshold. In such a case, the CPU 500 may control the feed timing of a subsequent sheet P so that the distance between the subsequent sheet P and a preceding sheet P fed by the pickup roller 22 equals the first value. There are cases in which the temperature of the pressing roller 15 is higher than the first threshold, or the image amount is less than the second threshold. In such a case, the CPU 500 may control the feed timing of a subsequent sheet P so that the distance equals the second value.

There are cases in which the temperature of the pressing roller 15 is lower than a threshold. In such cases, the CPU 500 may control the feed timing of a subsequent sheet P so that the distance between the subsequent sheet P and a preceding sheet P equals the first value. If the temperature of the pressing roller 15 is higher than the threshold, the CPU 500 may control the feed timing of a subsequent sheet P so that the distance between the subsequent sheet P and a preceding sheet P equals the second value. In such a manner, the image amount need not be taken into consideration.

The CPU 500 may acquire the movement speed of the peripheral surface of the pressing roller 15. There are cases in which the movement speed is lower than a first threshold, and the image amount is more than a second threshold. In such cases, the CPU 500 controls the feed timing of a subsequent sheet P so that the distance between the subsequent sheet P and a preceding sheet P fed by the pickup roller 22 equals the first value. There are also cases in which the movement speed is higher than the first threshold or the image amount is less than the second threshold. In such a case, the CPU 500 may control the feed timing of a subsequent sheet P so that the distance equals the second value.

If the movement speed is lower than a threshold, the CPU 500 may control the feed timing of a subsequent sheet P so that the distance between the subsequent sheet P and a preceding sheet P equals the first value. If the movement speed is higher than the threshold, the CPU 500 may control the feed timing of a subsequent sheet P so that the distance between the subsequent sheet P and a preceding sheet P equals the second value. In such a manner, the image amount need not be taken into consideration.

The CPU 500 may acquire the grammage of sheets P. There are cases in which the grammage is higher than a first threshold, and the image amount is more than a second threshold. In such a case, the CPU 500 controls the feed timing of a subsequent sheet P so that the distance between the subsequent sheet P and a preceding sheet P fed by the pickup roller 22 equals the first value. There are also cases in which the grammage is lower than the first threshold or the image amount is less than the second threshold. In such a case, the CPU 500 controls the feed timing of a subsequent sheet P so that the distance equals the second value.

If the grammage is higher than the first threshold, the CPU 500 may control the feed timing of a subsequent sheet P so that the distance between the subsequent sheet P and a preceding sheet P fed by the pickup roller 22 equals the first value. If the grammage is lower than the first threshold, the CPU 500 may control the feed timing of a subsequent sheet P so that the distance equals the second value. In such a manner, the image amount need not be taken into consideration.

The CPU 500 may acquire the environmental temperature. There are cases in which the environmental temperature is lower than a first threshold, and the image amount is more than a second threshold. In such a case, the CPU 500 may control the feed timing of a subsequent sheet P so that the distance between the subsequent sheet P and a preceding sheet P fed by the pickup roller 22 equals the first value. There are also cases in which the environmental temperature is higher than the first threshold or the image amount is less than the second threshold. In such a case, the CPU 500 may control the feed timing of a subsequent sheet P so that the distance equals the second value.

If the environmental temperature is lower than a threshold, the CPU 500 may control the feed timing of a subsequent sheet P so that the distance between the subsequent sheet P and a preceding sheet P equals the first value. If the environmental temperature is higher than the threshold, the CPU 500 may control the feed timing of a subsequent sheet P so that the distance between the subsequent sheet P and a preceding sheet P equals the second value. In such a manner, the image amount need not be taken into consideration.

The CPU 500 may adjust the quantity of sheets P on which images are formed per unit time by controlling the timing when sheets P are fed from the pickup roller 22.

The third region is a region of a sheet P that is dependent on the distance between the registration-roller pair 24 and the photosensitive drum 19. The image amount, the grammage, the temperature of the pressing roller 15, the environmental temperature, the expansion amount, and the peripheral speed are parameters that may lead to the occurrence of an image defect in the third region passing through the photosensitive drum 19 at the moment when the rear end of a sheet P has passed through the conveyance nip NC.

The CPU 500 can estimate the temperature of the pressing roller 15 based on the quantity of sheets P continuously passing through the fixing device 13, the pass time required for a sheet P to pass through the fixing device 13 or a no-pass time during which a sheet P is not passing through the fixing device 13, or the temperature of the heating film 14. The heating film 14 may be referred to as a belt or heating rotating member provided to the fixing device 13. The pressing roller 15 may be referred to as a pressing rotating member provided to the fixing device 13.

A first parameter may be at least one of the image amount and the grammage of sheets P. A second parameter may be at least one parameter different from the first parameter among the image amount, the grammage, the temperature of the pressing roller 15, the environmental temperature, the expansion amount, the peripheral speed, and the degree of wear of the registration-roller pair 24.

The CPU 500 may determine a threshold based on the second parameter. If the first parameter is more/higher than the threshold, the CPU 500 may control the feed timing of a subsequent sheet P so that the distance between the subsequent sheet P and a preceding sheet P fed by the pickup roller 22 equals the first value. If the first parameter is less/lower than the threshold, the CPU 500 may control the feed timing so that the distance equals the second value.

The first parameter may be at least one of the temperature of the pressing roller 15, the environmental temperature, the expansion amount, and the peripheral speed. The second parameter may be at least one of the image amount, the grammage, the temperature of the pressing roller 15, the environmental temperature, the expansion amount, the peripheral speed, and the degree of wear of the registration-roller pair 24. Note that the first parameter and the second parameter are different from one another.

The CPU 500 determines a threshold based on the second parameter. If the first parameter is less/lower than the threshold, the CPU 500 controls the feed timing of a subsequent sheet P so that the distance between the subsequent sheet P and a preceding sheet P fed by the pickup roller 22 equals the first value. If the first parameter is more/higher than the threshold, the CPU 500 controls the feed timing so that the distance equals the second value.

In the above-described embodiments, it is determined whether or not a numerical value is higher than a threshold; however, it may be determined whether or not a numerical value is higher than or equal to a threshold. Similarly, it may be determined whether or not a numerical value is less than a threshold, or it may be determined whether or not a numerical value is equal to or less than a threshold. In such a manner, cases in which a numerical value is equal to a threshold may be handled as appropriate.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-192415, filed Oct. 31, 2024, which is hereby incorporated by reference herein in its entirety.

What is claimed is:

1. An image forming apparatus comprising:
a storage unit that stores a recording material therein;
a feed unit that feeds the recording material stored in the storage unit;
a conveyance unit that forms a conveyance nip, the conveyance unit nipping the recording material fed by the feed unit in the conveyance nip to convey the recording material in a conveyance direction;
a transfer unit that is located on the conveyance-direction downstream side of the conveyance unit in the conveyance direction and that is adjacent to the conveyance unit, the transfer unit forming a transfer nip and nipping the recording material conveyed from the conveyance unit in the transfer nip to transfer a developed image onto a transfer-receiving surface of the recording material;
a fixing unit that is located on the conveyance-direction downstream side of the transfer unit in the conveyance direction, the fixing unit fixing the developed image having been transferred onto the recording material; and
a control unit that performs inter-material control for, when a first recording material and a subsequently-conveyed second recording material are being conveyed to the conveyance unit, performing conveyance in a state in which a material-to-material distance between the first and second recording materials is expanded,
wherein the control unit performs the inter-material control in a case where a developed image satisfying a condition for executing the inter-material control will be formed on the second recording material, and
the condition is that a ratio of an area of the developed image that is formed in a third region to an area of the third region exceeds a threshold, where the third region is a region between a first region and a second region, the first region and the second region are, respectively, a region that is downstream of a nipped region in the conveyance direction and that is located at a distance of 10 mm from a center line of the nipped region and a region that is upstream of the nipped region in the conveyance direction and that is located at a distance of 10 mm from the center line of the nipped region, and the nipped region is a region constituting part of the transfer-receiving surface of the second recording material and that is nipped in the transfer nip at a time point when a rear end of the second recording material in the conveyance direction has passed through the conveyance nip.

2. The image forming apparatus according to claim 1,
wherein, in a case where a developed image satisfying the condition will not be formed on the second recording material, the control unit does not perform the inter-material control for performing conveyance in the state in which the material-to-material distance is expanded.

3. The image forming apparatus according to claim 1,
wherein the transfer unit includes an image carrier and a transfer roller that forms the transfer nip together with the image carrier, and
the transfer roller and the fixing unit are rotationally driven by the same driving unit.

4. The image forming apparatus according to claim 1,
wherein the condition further includes a condition relating to at least one of: a grammage of the recording material; a temperature of the fixing unit; a temperature in an environment in which the fixing unit is installed; an expansion amount of the fixing unit; a movement speed of a peripheral surface of the fixing unit; and a degree of wear of the conveyance unit.

5. The image forming apparatus according to claim 1,
wherein the control unit determines whether or not the condition is satisfied based on image data serving as a source of the image that will be formed in the third region.

6. The image forming apparatus according to claim 1,
wherein the control unit:
controls the material-to-material distance to a first value in a case where the condition is satisfied; and
controls the material-to-material distance to a second value in a case where the condition is not satisfied, and
the first value is greater than the second value.

7. The image forming apparatus according to claim 1,
wherein a length of the third region in the conveyance direction of the recording material is greater than or equal to a length of the nipped region in the conveyance direction of the recording material.

8. The image forming apparatus according to claim 1,
wherein the fixing unit includes a heating portion that applies heat to the recording material and the image, and a pressing portion that applies pressure to the recording material and the image,
the control unit:
acquires an expansion amount of the pressing portion;
controls the material-to-material distance to a first value in a case where the expansion amount is less than a first threshold and the ratio of the area of the developed image that is formed in the third region to the area of the third region exceeds the threshold; and
controls the material-to-material distance to a second value in a case where the expansion amount is more than the first threshold or the ratio of the area of the developed image that is formed in the third region to the area of the third region does not exceed the threshold, and
the first value is greater than the second value.

9. The image forming apparatus according to claim 1,
wherein the fixing unit includes a heating portion that applies heat to the recording material and the image, and a pressing portion that applies pressure to the recording material and the image,
the control unit:
acquires an expansion amount of the pressing portion;
controls the material-to-material distance to a first value in a case where the expansion amount is less than a first threshold and a halftone image will be formed over the entire third region; and
controls the material-to-material distance to a second value in a case where the expansion amount is more than the first threshold or a halftone image will not be formed over the entire third region, and
the first value is greater than the second value.

10. The image forming apparatus according to claim 1,
wherein the control unit:
acquires a temperature of the fixing unit;
controls the material-to-material distance to a first value in a case where the temperature is lower than a first threshold and the ratio of the area of the developed image that is formed in the third region to the area of the third region exceeds the threshold; and
controls the material-to-material distance to a second value in a case where the temperature is higher than the first threshold or the ratio of the area of the developed image that is formed in the third region to the area of the third region does not exceed the threshold, and
the first value is greater than the second value.

11. The image forming apparatus according to claim 10,
wherein the control unit estimates the temperature of the fixing unit based on:
a quantity of recording materials continuously passing through the fixing unit;
a pass time required for the recording material to pass through the fixing unit or a no-pass time during which the recording material is not passing through the fixing unit; and
a temperature of a heating portion provided in the fixing unit.

12. The image forming apparatus according to claim 1,
wherein the fixing unit includes a heating portion that applies heat to the recording material and the image, and a pressing portion that applies pressure to the recording material and the image,
the control unit:
acquires a movement speed of a peripheral surface of the pressing portion;
controls the material-to-material distance to a first value in a case where the movement speed is lower than a first threshold and the ratio of the area of the developed image that is formed in the third region to the area of the third region exceeds the threshold; and
controls the material-to-material distance to a second value in a case where the movement speed is higher than the first threshold or the ratio of the area of the developed image that is formed in the third region to the area of the third region does not exceed the threshold, and
the first value is greater than the second value.

13. The image forming apparatus according to claim 1,
wherein the control unit:
acquires a grammage of the recording material;
controls the material-to-material distance to a first value in a case where the grammage is higher than a first threshold and the ratio of the area of the developed image that is formed in the third region to the area of the third region exceeds the threshold; and
controls the material-to-material distance to a second value in a case where the grammage is lower than the first threshold or the ratio of the area of the developed image that is formed in the third region to the area of the third region does not exceed the threshold, and
the first value is greater than the second value.

14. The image forming apparatus according to claim 1,
wherein the control unit:
acquires a temperature in an environment in which the fixing unit is installed;
controls the material-to-material distance to a first value in a case where the temperature is lower than a first threshold and the ratio of the area of the developed image that is formed in the third region to the area of the third region exceeds the threshold; and
controls the material-to-material distance to a second value in a case where the temperature is higher than the first threshold or the ratio of the area of the developed image that is formed in the third region to the area of the third region does not exceed the threshold, and
the first value is greater than the second value.

15. The image forming apparatus according to claim 1,
wherein the control unit controls a quantity of recording materials on which images are formed per unit time by controlling the material-to-material distance.

16. An image forming apparatus comprising:
a storage unit that stores a recording material therein;
a feed unit that feeds the recording material stored in the storage unit;
a conveyance unit that forms a conveyance nip, the conveyance unit nipping the recording material fed by the feed unit in the conveyance nip to convey the recording material in a conveyance direction;
a transfer unit that is located on the conveyance-direction downstream side of the conveyance unit in the conveyance direction and that is adjacent to the conveyance unit, the transfer unit forming a transfer nip and nipping the recording material conveyed from the conveyance unit in the transfer nip to transfer a developed image onto a transfer-receiving surface of the recording material;
a fixing unit that is located on the conveyance-direction downstream side of the transfer unit in the conveyance direction, the fixing unit fixing the developed image having been transferred onto the recording material; and
a control unit that performs inter-material control for, when a first recording material and a subsequently-conveyed second recording material are being conveyed to the conveyance unit, performing conveyance in a state in which a material-to-material distance between the first and second recording materials is expanded,
wherein the control unit performs the inter-material control in a case where a developed image satisfying a condition for executing the inter-material control will be formed on the second recording material, and
the condition is that a halftone image will be formed over an entire third region, where the third region is a region between a first region and a second region, the first region and the second region are, respectively, a region that is downstream of a nipped region in the conveyance direction and that is located at a distance of 10 mm from a center line of the nipped region and a region that is upstream of the nipped region in the conveyance direction and that is located at a distance of 10 mm from the center line of the nipped region, and the nipped region is a region constituting part of the transfer-receiving surface of the second recording material and that is nipped in the transfer nip at a time point when a rear end of the second recording material in the conveyance direction has passed through the conveyance nip.

17. The image forming apparatus according to claim 16,
wherein, in a case where a developed image satisfying the condition will not be formed on the second recording material, the control unit does not perform the inter-material control for performing conveyance in the state in which the material-to-material distance is expanded.

18. The image forming apparatus according to claim 16,
wherein the transfer unit includes an image carrier and a transfer roller that forms the transfer nip together with the image carrier, and
the transfer roller and the fixing unit are rotationally driven by the same driving unit.

19. The image forming apparatus according to claim 16,
wherein the condition further includes a condition relating to at least one of: a grammage of the recording material; a temperature of the fixing unit; a temperature in an environment in which the fixing unit is installed; an expansion amount of the fixing unit; a movement speed of a peripheral surface of the fixing unit; and a degree of wear of the conveyance unit.

20. The image forming apparatus according to claim 16,
wherein the control unit determines whether or not the condition is satisfied based on image data serving as a source of the image that will be formed in the third region.
